(19) United States
(12) Patent Application Publication
(10) Pub. No.: US 2024/0387871 A1
(43) Pub. Date: Nov. 21, 2024

(54) NON-AQUEOUS ELECTROLYTE SECONDARY BATTERY, BATTERY PACK, AND BATTERY MODULE

(71) Applicant: Prime Planet Energy & Solutions, Inc., Tokyo (JP)

(72) Inventors: Hideaki FUJITA, Kyotanabe-shi (JP); Daisuke NISHIDE, Kobe-shi (JP); Nao NOMURA, Kobe-shi (JP)

(21) Appl. No.: 18/660,231

(22) Filed: May 10, 2024

(30) Foreign Application Priority Data
May 18, 2023 (JP) 2023-082005

(51) Int. Cl. H01M 10/0567; H01M 10/0568; H01M 10/0587; H01M 10/42

(52) U.S. Cl. CPC H01M 10/0567; H01M 10/0568; H01M 10/0587; H01M 10/4235; H01M 2300/0025

(57) ABSTRACT

The present disclosure relates to a non-aqueous electrolyte secondary battery comprising a wound-type electrode assembly and an electrolyte solution. In the non-aqueous electrolyte secondary battery according to the present disclosure, a dimension of at least one of a positive electrode active material layer and a negative electrode active material layer in a direction of an axis of winding of the electrode assembly is 150 mm or more, the electrolyte solution includes an electrolyte salt and LiFSO_{3,} the electrolyte salt includes at least one of LiPF₆ and LiBF_{4,} a ratio of a total concentration A (mol/L) of LiPF₆ and LiBF₄ to a concentration B (mol/L) of LiFSO₃ in the electrolyte solution, which is expressed as an A/B ratio, is from 5 to 12, and a pressure of 0.5 MPa or more is applied to the electrode assembly in an electrode plate stacking direction.

### CROSS REFERENCE TO RELATED APPLICATIONS

This nonprovisional application is based on Japanese Patent Application No. 2023-082005 filed on May 18, 2023, with the Japan Patent Office, the entire contents of which are hereby incorporated by reference.

### BACKGROUND OF THE INVENTION

### Field of the Invention

The present disclosure relates to a non-aqueous electrolyte secondary battery, and it also relates to a battery pack and a battery module including the same.

### Description of the Background Art

Aiming at improving post-endurance input-output properties and impedance properties of non-aqueous electrolyte secondary batteries, Japanese Patent Laying-Open No. 2013-152956 suggests a non-aqueous electrolyte solution that includes LiPF₆ and LiFSO₃, and Japanese Patent Laying-Open No. 2011-187440 suggests limiting the ratio of the molar content of FSO₃ to the molar content of PF₆ to a certain range.

### SUMMARY OF THE INVENTION

When a non-aqueous electrolyte secondary battery that includes a wide electrode assembly (for instance, one that has an active material layer with a longitudinal dimension of 15 cm or more) is applied with pressure in the electrode plate stacking direction of the electrode assembly, salt concentrations during high-rate cycles tend to be nonuniform, the electric potential of the positive electrode tends to rise greatly, and capacity degradation tends to occur. When an electrolyte solution that includes LiFSO₃ is used, SO₃F⁻ tends to be adsorbed on the surface of the positive electrode active material, and formation of a film of LiF derived from electrolyte salts tends to be inhibited: and when the cell size is large, salt concentrations during high-rate charging cycles tend to be markedly nonuniform and salt concentrations at an end of an electrode plate tend to be decreased. As a result, the electric potential at an end of the positive electrode plate rises to reach an electric potential at which the positive electrode active material reacts with strong-acid SO₃F⁻, and thereby, from the positive electrode active material which is not sufficiently covered with a LiF film, transition metal elutes to be deposited on the negative electrode plate.

An object of the present disclosure is to provide a non-aqueous electrolyte secondary battery that comprises a wide electrode assembly to which pressure is applied in the electrode plate stacking direction of the electrode assembly and that is low in output resistance and reduced in cycling performance degradation, as well as a battery pack and a battery module including the same.

The present disclosure provides a non-aqueous electrolyte secondary battery, a battery pack, and a battery module as described below.

[1] A non-aqueous electrolyte secondary battery comprising:
an electrode assembly; and
an electrolyte solution, wherein
the electrode assembly is a wound-type electrode assembly that is formed by winding a positive electrode plate and a negative electrode plate together with a separator interposed therebetween,
the positive electrode plate comprises a positive electrode active material layer,
the negative electrode plate comprises a negative electrode active material layer,
a dimension of at least one of the positive electrode active material layer and the negative electrode active material layer in a direction of an axis of winding of the electrode assembly is 150 mm or more,
the electrolyte solution includes an electrolyte salt and LiFSO₃,
the electrolyte salt includes at least one of LiPF₆ and LiBF₄,
when a total concentration of LiPF₆ and LiBF₄ in the electrolyte solution is defined as A (mol/L) and a concentration of LiFSO₃ in the electrolyte solution is defined as B (mol/L), a ratio of A to B which is expressed as an A/B ratio is from 5 to 12, and
a pressure of 0.5 MPa or more is applied to the electrode assembly in an electrode plate stacking direction.

[2] The non-aqueous electrolyte secondary battery according to [1], wherein the A/B ratio is from 6.7 to 10.

[3] The non-aqueous electrolyte secondary battery according to [1] or [2], wherein the total concentration of LiPF₆ and LiBF₄ in the electrolyte solution defined as A is from 1 to 1.5 mol/L.

[4] The non-aqueous electrolyte secondary battery according to any one of [1] to [3], wherein the concentration of LiFSO₃ in the electrolyte solution defined as B is from 0.1 to 0.25 mol/L.

[5] The non-aqueous electrolyte secondary battery according to any one of [1] to [4], wherein a length of the electrode assembly in a direction parallel to the axis of winding is 180 mm or more.

[6] A battery pack comprising the non-aqueous electrolyte secondary battery according to any one of [1] to [5].

[7] A battery module comprising the non-aqueous electrolyte secondary battery according to any one of [1] to [5].

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view illustrating an example configuration of a non-aqueous electrolyte secondary battery according to the present embodiment.

FIG. 2 is a schematic view illustrating an example configuration of an electrode assembly according to the present embodiment.

FIG. 3 is a schematic cross-sectional view illustrating an example configuration of an electrode assembly according to the present embodiment.

FIG. 4 is a schematic view illustrating an example configuration of an electrode assembly according to the present embodiment.

FIG. 5 is a perspective view illustrating an example of a battery pack according to the present embodiment.

FIG. 6 is a perspective view illustrating an example of a battery module according to the present embodiment.

FIG. 7 is a schematic view for describing a method for restraining a battery in Examples.

### DESCRIPTION OF THE PREFERRED EMBODIMENTS

Next, a description will be given of embodiments of the present invention with reference to drawings, but the below embodiments do not limit the scope of the present invention. In each drawing below, the scale has been changed as appropriate for the purpose of assisting the understanding of the components; therefore, the scale of the components in the drawings may not necessarily coincide with the actual scale of the components.

Herein, a singular form also includes its plural meaning, unless otherwise specified. For example, “a particle” may mean not only “one particle” but also “a group of particles (powder, particles)”.

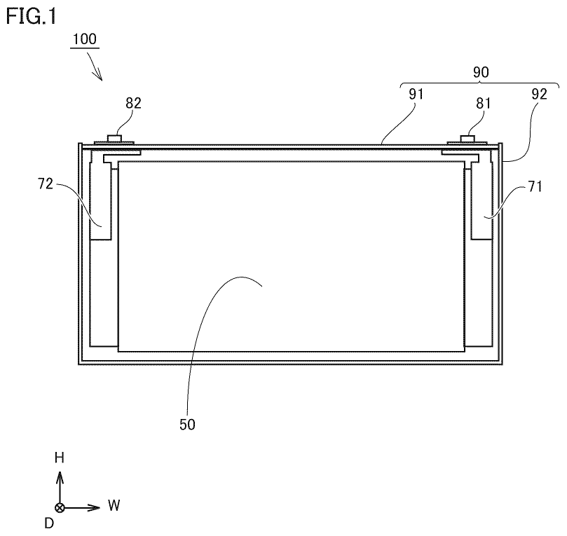

FIG. 1 is a schematic view illustrating an example configuration of a battery according to the present embodiment. A battery 100 may be used for any purpose of use. Battery 100 may be used as a main electric power supply or a motive force assisting electric power supply in an electric vehicle and/or the like. A plurality of batteries 100 may be connected together to form a battery module or a battery pack. The battery module and the battery pack are described below. Battery 100 may have a rated capacity from 1 to 300 Ah, for example.

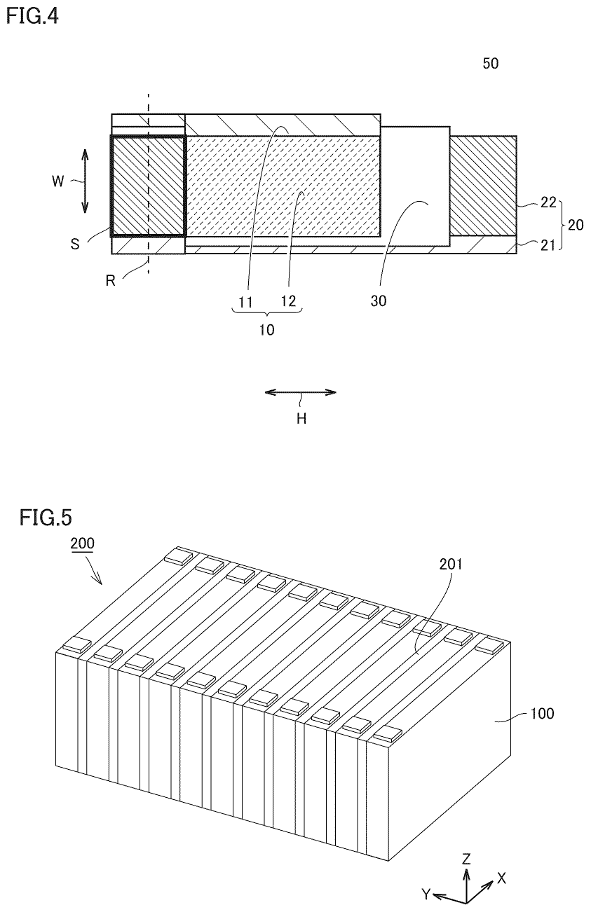

Battery 100 includes an electrode assembly 50 and an electrolyte solution. As illustrated in FIG. 1, battery 100 can further include an exterior package 90. Exterior package 90 accommodates electrode assembly 50 and the electrolyte solution (not illustrated). Exterior package 90 is prismatic (a flat, rectangular parallelepiped). Exterior package 90 may be made of aluminum (Al) alloy, for example. To electrode assembly 50, a pressure of 0.5 MPa or more is applied in the electrode plate stacking direction (the D-axis direction in FIG. 1). The pressure may be applied from outside of electrode assembly 50. The pressure applied to the electrode assembly may be applied to the region specified as an electrode assembly area S in FIG. 4. FIG. 4 is explained below. Electrode assembly 50 may be restrained inside the exterior package 90. The force that restrains electrode assembly 50 may be the pressure mentioned above. The force that restrains electrode assembly 50 may be the force that restrains a plurality of batteries and inter-cell separators inside a battery module described below, for example.

Exterior package 90 may include a sealing plate 91 and an exterior container 92, for example. Sealing plate 91 closes the opening of exterior container 92. Sealing plate 91 and exterior container 92 may be bonded together by laser processing and/or the like, for example. The configuration of exterior package 90 is not particularly limited. For example, exterior package 90 may be in the shape of a pouch. More specifically, exterior package 90 may be a pouch made of Al-laminated film, and/or the like.

To sealing plate 91, a positive electrode terminal 81 and a negative electrode terminal 82 are provided. To sealing plate 91, an inlet (not illustrated), a gas-discharge valve (not illustrated), and/or the like may further be provided. Through the inlet, the electrolyte solution may be injected into exterior package 90. The inlet may be closed with a plug and/or the like, for example. Positive electrode terminal 81 is connected with electrode assembly 50 by a positive electrode current-collecting member 71. Positive electrode current-collecting member 71 may be an Al plate and/or the like, for example. Negative electrode terminal 82 is connected with electrode assembly 50 by a negative electrode current-collecting member 72. Negative electrode current-collecting member 72 may be a copper (Cu) plate and/or the like, for example.

Electrode assembly 50 is a wound-type electrode assembly that is formed by winding a positive electrode plate and a negative electrode plate together with a separator interposed therebetween. The positive electrode plate, the negative electrode plate, and the separator may form a stack that has a belt-like planar shape, for example. This belt-like stack may be wound spirally to form a wound assembly. The wound assembly may be tubular, for example. This tubular wound assembly may be compressed in a radial direction to form a flat electrode assembly 50. The dimension of electrode assembly 50 in the direction of the axis of winding (hereinafter also called the widthwise direction) (the W-axis direction in FIG. 1) may be 180 mm or more, or may be from 180 mm to 300 mm, for example.

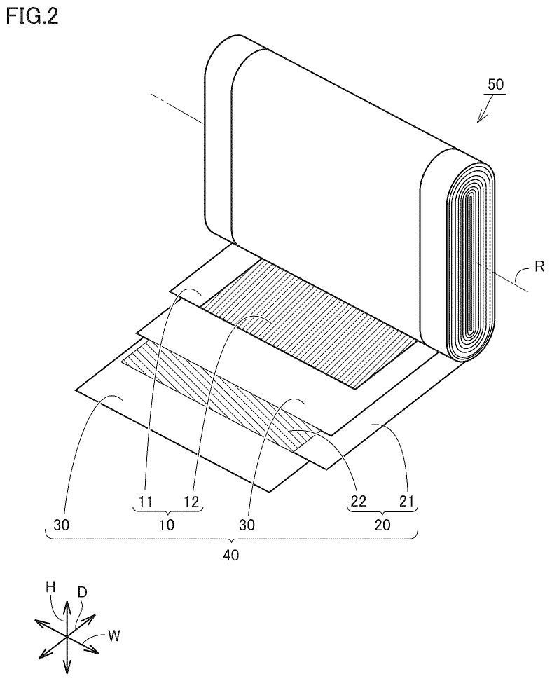

FIG. 2 is a schematic view illustrating an example configuration of an electrode assembly according to the present embodiment. Electrode assembly 50 in FIG. 2 is a wound-type electrode assembly that has an axis of winding, R, parallel to the W-axis direction. Electrode assembly 50 includes a stack 40. Electrode assembly 50 may consist essentially of stack 40. Stack 40 includes a positive electrode plate 10, a negative electrode plate 20, and a separator 30. At least part of separator 30 is interposed between positive electrode plate 10 and negative electrode plate 20. Separator 30 separates positive electrode plate 10 from negative electrode plate 20. Each of positive electrode plate 10 and negative electrode plate 20 may be bonded to separator 30. Stack 40 may include a single separator 30. Stack 40 may include two separators 30. For example, positive electrode plate 10 may be sandwiched between two separators 30. For example, negative electrode plate 20 may be sandwiched between two separators 30. For example, stack 40 may be formed by stacking separator 30 (a first separator), negative electrode plate 20, separator 30 (a second separator), and positive electrode plate 10 in this order.

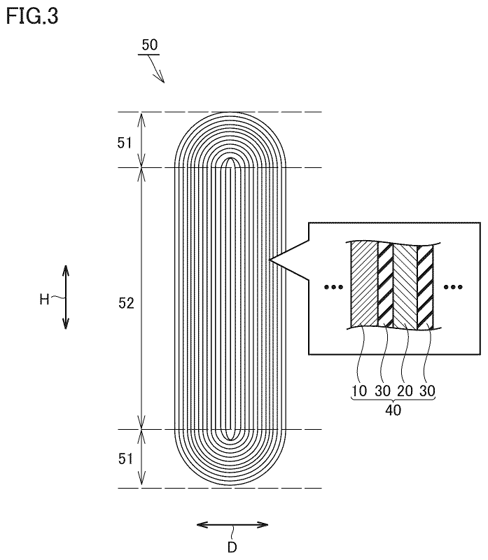

FIG. 3 is a schematic cross-sectional view illustrating an example configuration of an electrode assembly according to the present embodiment. In FIG. 3, a cross section orthogonal to the axis of winding is illustrated. Electrode assembly 50 includes a curved portion 51 and a flat portion 52. At curved portion 51, stack 40 is curved. At curved portion 51, stack 40 may have the shape of an arc. At flat portion 52, stack 40 is flat. Flat portion 52 is located between two curved portions 51. Flat portion 52 connects two curved portions 51. The thickness of stack 40 refers to the total thickness of positive electrode plate 10, negative electrode plate 20, and separator 30 included in stack 40. The thickness of stack 40 may be from 100 to 400 μm, or from 1 to 300 μm, for example. The thickness of stack 40 is the thickness thereof in the electrode assembly stacking direction (the D-axis direction in FIG. 3).

The number of positive electrode plates 10 stacked in electrode assembly 50 is not particularly limited. The number of the stacked positive electrode plates 10 refers to the number of times a straight line crossing electrode assembly 50 in the stacking direction crosses positive electrode plates 10. The stacking direction refers to the direction in which positive electrode plate 10, negative electrode plate 20, and separator 30 are stacked in electrode assembly 50. The stacking direction in wound-type electrode assembly 50 is parallel to the direction of the thickness of positive electrode plate 10, negative electrode plate 20, and separator 30 at flat portion 52 (the D-axis direction in FIG. 3).

Electrode assembly 50 can be produced in the following way: positive electrode plate 10 and negative electrode plate 20 are stacked with separator 30 interposed therebetween in such a manner that an aluminum foil of the positive electrode plate and a copper foil of the negative electrode plate are exposed at respective ends, as illustrated in FIG. 4, to form a stack, and then the resulting stack is wound, with one end of the stack serving as the axis of winding, R.

The number of the stacked positive electrode plates 10 may be from 2 to 100, for example. The number of the stacked negative electrode plates 20 may be from 2 to 100, for example. The number of the stacked separators 30 may be from 4 to 200, for example. The number of the stacked negative electrode plates 20 and the number of the stacked separators 30 may be counted in the same manner as in the counting of the number of the stacked positive electrode plates 10.

Positive electrode plate 10 comprises a positive electrode active material layer. In FIG. 1, the dimension of the positive electrode active material layer in a direction parallel to the direction of the axis of winding of electrode assembly 50 (namely, in a direction parallel to the W-axis direction) is 150 mm or more, and, for example, it may be 180 mm or more, or may be 200 mm or more, or may be 220 mm or more, and may be 300 mm or less. The positive electrode active material layer is described below.

Negative electrode plate 20 comprises a negative electrode active material layer. In FIG. 1, the dimension of the negative electrode active material layer in a direction parallel to the direction of the axis of winding of electrode assembly 50 (namely, in a direction parallel to the W-axis direction) is 150 mm or more, and, for example, it may be 180 mm or more, or may be 200 mm or more, or may be 220 mm or more, and may be 300 mm or less. The negative electrode active material layer is described below.

Positive electrode plate 10 includes a positive electrode core material 11 and a positive electrode active material layer 12 (see FIG. 2). Positive electrode active material layer 12 may be placed on the surface of positive electrode core material 11. Positive electrode active material layer 12 may be placed on only one side of positive electrode core material 11. Positive electrode active material layer 12 may be placed on both sides of positive electrode core material 11. Positive electrode core material 11 is a conductive sheet. Positive electrode core material 11 may include pure Al foil, Al alloy foil, and/or the like, for example. Positive electrode core material 11 may have a thickness from 10 to 30 μm, for example. At one end of electrode assembly 50 in the widthwise direction (the W-axis direction in FIG. 2), positive electrode core material 11 may be exposed. To the exposed portion of positive electrode core material 11, positive electrode current-collecting member 71 may be bonded (see FIG. 1). The thickness of positive electrode plate 10 may be from 20 to 290 μm, or from 50 to 250 μm, or from 100 to 200 μm, for example. The dimension of positive electrode plate 10 in the longitudinal direction may be from 0.5 to 10 m, or from 1 to 5 m, for example.

The thickness of positive electrode active material layer 12 refers to the total thickness of positive electrode active material layer(s) 12 included in stack 40. For example, when positive electrode active material layer 12 is formed on both sides of positive electrode plate 10, the thickness of positive electrode active material layer 12 refers to the total thickness of positive electrode active material layers 12 on both sides (namely, two of them). The thickness of positive electrode active material layer 12 may be from 10 to 260 μm, or may be from 20 to 60 μm, or may be from 30 to 50 μm, for example. It should be noted that the thickness of positive electrode active material layer 12 on one side (namely, one piece of it) may be from 5 to 130 μm, or may be from 10 to 30 μm, or may be from 15 to 25 μm, for example.

Positive electrode active material layer 12 can include a lithium-(transition metal) composite oxide. The lithium-(transition metal) composite oxide includes, for example, at least one selected from the group consisting of LiCoO₂, LiNiO₂, LiMnO₂, LiMn₂O₄, Li (NiCoMn) O₂, Li (NiCoAl) O₂, and LiFePO₄. In a composition formula such as “Li (NiCoMn)O₂”, for example, the constituents within the parentheses are collectively regarded as a single unit in the entire composition ratio. That is, the relationship of “C_{Ni}+C_{Co}+C_{Mn}=1” is satisfied. For example, “C_{Ni}” refers to the composition ratio of Ni. As long as (NiCoMn) is collectively regarded as a single unit in the entire composition ratio, the amounts of individual constituents are not particularly limited. Positive electrode active material layer 12 can include positive electrode active material particles. The positive electrode active material particles may include any component. The positive electrode active material particles may include the above-described lithium-(transition metal) composite oxide.

For example, positive electrode active material layer 12 may further include a conductive material, a binder, and/or the like, in addition to the positive electrode active material particles. For example, positive electrode active material layer 12 may consist essentially of a conductive material in an amount from 0.1 to 10% and a binder in an amount from 0.1 to 10% in terms of mass fraction, with the remainder being made up of the positive electrode active material particles. The conductive material may include a carbon material and/or the like, for example. The binder may include any component. The binder may include polyvinylidene difluoride (PVdF) and/or the like, for example. The packing density of positive electrode active material layer 12 (after compression) may be from 2.0 g/cm³ to 4.0 g/cm³, for example.

Negative electrode plate 20 includes a negative electrode core material 21 and a negative electrode active material layer 22 (see FIG. 2). Negative electrode active material layer 22 may be placed on the surface of negative electrode core material 21. Negative electrode active material layer 22 may be placed on only one side of negative electrode core material 21. Negative electrode active material layer 22 may be placed on both sides of negative electrode core material 21. Negative electrode core material 21 is a conductive sheet. Negative electrode core material 21 may include pure Cu foil, Cu alloy foil, and/or the like, for example. Negative electrode core material 21 may have a thickness from 5 to 30 μm, for example. At one end of negative electrode plate 20 in the widthwise direction (the W-axis direction in FIG. 2), negative electrode core material 21 may be exposed. To the exposed portion of negative electrode core material 21, negative electrode current-collecting member 72 may be bonded (see FIG. 1). The thickness of negative electrode plate 20 may be from 20 to 290 μm, or from 50 to 250 μm, or from 100 to 200 μm, for example. The dimension of negative electrode plate 20 in the longitudinal direction may be from 0.5 to 10 m, or from 1 to 5 m, for example.

The thickness of negative electrode active material layer 22 refers to the total thickness of negative electrode active material layer(s) 22 included in stack 40. For example, when negative electrode active material layer 22 is formed on both sides of negative electrode plate 20, the thickness of negative electrode active material layer 22 refers to the total thickness of negative electrode active material layers 22 on both sides (namely, two of them). The thickness of negative electrode active material layer 22 may be from 10 to 260 μm, or may be from 40 to 80 μm, or may be from 50 to 70 μm, for example. It should be noted that the thickness of negative electrode active material layer 22 on one side (namely, one piece of it) may be from 5 to 130 μm, or may be from 20 to 40 μm, or may be from 25 to 35 μm, for example. The packing density of negative electrode active material layer 22 (after compression) may be from 1.0 g/cm³ to 1.8 g/cm³, for example.

Negative electrode active material layer 22 may include, for example, at least one selected from the group consisting of graphite, silicon, silicon oxide, tin, tin oxide, and Li₄Ti₅O₁₂, as a negative electrode active material. Negative electrode active material layer 22 can include negative electrode active material particles. The negative electrode active material particles may include the above-described negative electrode active material. Negative electrode active material layer 22 may consist essentially of the negative electrode active material particles. The negative electrode active material particle may be a composite particle, for example. The negative electrode active material particle may include a base material particle and a film, for example. The surface of the base material particle may be covered with the film. The base material particle may include graphite and/or the like, for example. The film may include amorphous carbon and/or the like, for example.

Negative electrode active material layer 22 may further include a conductive material, a binder, and/or the like, in addition to the negative electrode active material particles. For example, negative electrode active material layer 22 may consist essentially of a conductive material in an amount from 0 to 10% and a binder in an amount from 0.1 to 10% in terms of mass fraction, with the remainder being made up of the negative electrode active material particles. The conductive material may include any component. The conductive material may include a carbon material and/or the like, for example. The binder may include any component. The binder may include at least one selected from the group consisting of carboxymethylcellulose (CMC) and styrene-butadiene rubber (SBR), for example.

Separator 30 includes a resin film. Separator 30 may consist essentially of a resin film. Separator 30 may have a monolayer structure consisting of a single resin film, or may have a multilayer structure consisting of two or more resin films. When separator 30 has a multilayer structure, the resin films may be of different types from each other. The resin film may consist essentially of a polyolefin-based material, for example. The polyolefin-based material may include, for example, at least one selected from the group consisting of polyethylene (PE) and polypropylene (PP). When separator 30 has a multilayer structure, separator 30 may have a three-layer structure consisting of a resin film made of PP, a resin film made of PE, and a resin film made of PP, for example. The resin film may have a thickness from 10 to 50 μm, or may have a thickness from 10 to 30 μm, or may have a thickness from 10 to 20 μm, for example. The resin film may be porous.

The electrolyte solution is a liquid electrolyte. The electrolyte solution includes an electrolyte salt and LiFSO3. In the electrolyte solution, the electrolyte salt may be dissolved in a solvent which is described below.

The electrolyte salt includes at least one of LiPF₆ and LiBF₄. The electrolyte salt may include LiPF₆ alone, or may include LiBF₄ alone, or may include both LiPF₆ and LiBF₄. When the total concentration of LiPF₆ and LiBF₄ in the electrolyte solution is defined as A (mol/L) and the concentration of LiFSO₃ in the electrolyte solution is defined as B (mol/L), the ratio of A to B which is expressed as an A/B ratio is from 5 to 12. When the A/B falls within the above-described range, which means that at least one of LiPF₆ and LiBF₄ is present in a sufficient amount relative to LiFSO₃, it is conjectured that a LiF film is sufficiently formed on the surface of the positive electrode active material and, thereby, transition metal elution from the active material due to LiFSO₃ tends not to occur, making it possible to obtain a battery that is capable of exhibiting low output resistance and good cycling performance. The A/B ratio is preferably from 5 to 10, more preferably from 6.7 to 10, from the viewpoints of output resistance and cycling performance.

The total concentration of LiPF₆ and LiBF₄ in the electrolyte solution, which is defined as A, may be from 1.0 to 1.5 mol/L, for example. The concentration of LiFSO₃ in the electrolyte solution, which is defined as B, may be from 0.1 to 0.25 mol/L, for example.

The electrolyte solution can include a solvent. The solvent is aprotic. The solvent may include any component. The solvent can include at least one selected from the group consisting of carbonate-based solvent, 1,2-dimethoxyethane (DME), methyl formate (MF), methyl acetate (MA), methyl propionate (MP), and γ-butyrolactone (GBL). Preferably, the solvent includes a carbonate-based solvent. Examples of the carbonate-based solvent include ethylene carbonate (EC), propylene carbonate (PC), butylene carbonate (BC), dimethyl carbonate (DMC), ethyl methyl carbonate (EMC), diethyl carbonate (DEC), and the like.

The battery according to the present disclosure can exhibit a capacity retention of 90% or more in cycling performance evaluation. When the cycle capacity retention is 90% or more, the battery can exhibit good cycling performance. The cycling performance evaluation is carried out by a method that is described below in the Examples section.

A method of producing a battery can include, for example, a placement step that involves placing an electrode assembly in an exterior package, and an injection step that involves injecting an electrolyte solution. In the placement step, an aluminum foil of a positive electrode plate current-collecting member and an aluminum plate of the electrode assembly for external current collection can be welded together, and a copper foil of a negative electrode plate current-collecting member and a copper plate of the electrode assembly for external current collection can be welded together, and then the resultants can be inserted into an exterior package made of an aluminum laminated film. In the injection step, the above-described electrolyte solution can be injected. After injection, sealing and welding can be carried out to obtain a battery.

### Battery Pack

FIG. 5 is a perspective view of a battery pack 200. Battery pack 200 in FIG. 5 includes batteries 100 and inter-cell separators 201. Batteries 100 and inter-cell separators 201 are alternately aligned in the Y-axis direction (a first direction).

Batteries 100 are prismatic battery cells, and a plurality of them are provided in the Y-axis direction. Batteries 100 are electrically connected to each other via a bus bar (not illustrated).

Each inter-cell separator 201 is provided between batteries 100. Inter-cell separators 201 prevent unintended electrical connection between batteries 100 that are located adjacent to each other. Inter-cell separators 201 ensure electrical insulation between batteries 100 that are located adjacent to each other.

### Battery Module

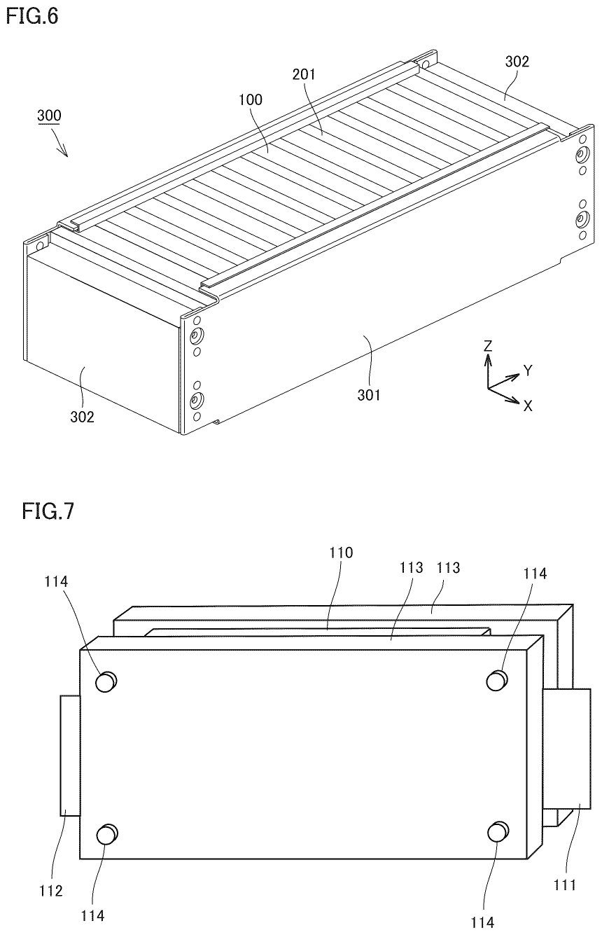

FIG. 6 is a perspective view of a battery module 300. As illustrated in FIG. 3, battery module 300 comprises batteries 100, inter-cell separators 201, a restraint member 301, and end plates 302.

Batteries 100 and inter-cell separators 201 that are alternately aligned in the Y-axis direction (the first direction) are pressed by end plates 302 and restrained between two end plates 302.

End plates 302 are placed at both ends in the Y-axis direction. End plates 302 are secured to a platform, such as a case, that accommodates battery module 300. Restraint member 301 connects two end plates 302 to one another and restrains batteries 100 and inter-cell separators 201 in the Y-axis direction.

Restraint member 301 is secured to end plates 302 while compression force is being applied in the Y-axis direction to a stack formed of batteries 100, inter-cell separators 201, and end plates 302, and, then, the compression force is relieved, which causes tensile force to be applied to restraint member 301 that connects two end plates 302 to each other. As a reaction to this, two end plates 302 are pressed toward each other by restraint member 301. As a result, battery module 300 is formed.

Battery module 300 is placed inside a pack case to form a battery pack (Cell-Module-Pack structure). Alternatively, a structure in which battery pack 200 illustrated in FIG. 5 is directly supported by the wall of the pack case may be formed (Cell-to-Pack structure).

### EXAMPLES

In the following, the present invention will be described in further detail by way of Examples. “%” and “part(s)” in Examples refer to mass % and part(s) by mass, respectively, unless otherwise specified.

### Example 1

### [Production of Positive Electrode Plate]

A composite material for a positive electrode active material layer having a composite material composition of LiNiCoMnO₂:AB:pVdF=100:1:1 (wt %) was mixed with NMP to produce a positive electrode composite material slurry. The resultant was applied to an aluminum foil of a positive electrode current collector, dried, and then compressed to a certain thickness and cut into a certain width, and thereby a positive electrode plate was produced that had two portions aligned in the widthwise direction, namely, a portion where a positive electrode active material layer was formed on the aluminum foil and a portion where an active material layer was not formed. The width of the formed positive electrode active material layer was 150 mm.

### [Production of Negative Electrode Plate]

As a negative electrode active material, graphite was used. A composite material for a negative electrode active material layer having a composite material composition of graphite: SBR:CMC=100:1:1 (wt %) was mixed with water to produce a negative electrode composite material slurry. The resulting negative electrode composite material slurry was applied to a copper foil of a negative electrode current collector, dried, and then compressed to a certain thickness and cut into a certain width, and thereby a negative electrode plate was produced that had a portion where a negative electrode active material layer was formed on the copper foil and a portion where an active material layer was not formed. The width of the formed negative electrode active material layer was 154 mm.

### [Production of Electrode Assembly]

An electrode assembly having a composition specified in FIG. 4 was produced in the manner described below. The positive electrode plate and the negative electrode plate were stacked with a separator composed of three layers (polypropylene-polyethylene-polypropylene) being interposed therebetween, in such a manner that the aluminum foil of the positive electrode and the copper foil of the negative electrode were exposed at respective ends, to produce a stack, and then the resulting stack was wound, with one end of the stack serving as the axis of winding, to produce an electrode assembly.

### [Production of Non-Aqueous Electrolyte Secondary Battery]

The aluminum foil of the positive electrode plate current collector and an aluminum plate for external current collection were welded together, and the copper foil of the negative electrode plate current collector and a copper plate for external current collection were welded together, and then the resultants were inserted into an exterior package made of an aluminum laminated film, into which an electrolyte solution 1 was injected, followed by sealing the laminated film.

### Electrolyte Solution 1

Solvent: EC/EMC (volume ratio, 1:3)

LiPF₆ concentration (concentration A): 1 mol/L

LiFSO₃ concentration (concentration B): 0.1 mol/L

Then, as illustrated in FIG. 7, restraint plates made of stainless steel were placed to sandwich the battery from both sides in a direction vertical to the axis of winding of the electrode assembly, and the restraint plates were fastened to each other with screws and nuts at four corners, followed by restraining the batteries with a load adjusted so that a restraining pressure of 0.5 MPa was to be applied to the electrode assembly area S (its widthwise direction was the width of the formed positive electrode active material layer) illustrated in FIG. 4, and, thereby, a non-aqueous electrolyte secondary battery was produced.

### Comparative Example 1

A non-aqueous electrolyte secondary battery was produced in the same manner as in Example 1 except that the width to form the positive electrode active material layer in [Production of Positive Electrode Plate] above was changed to 100 mm, the width to form the negative electrode active material layer in [Production of Negative Electrode Plate] above was changed to 104 mm, and electrolyte solution 1 was replaced by an electrolyte solution 2 described below.

### Electrolyte Solution 2

Solvent: EC/EMC (volume ratio, 1:3)

LiPF₆ concentration (concentration A): 1 mol/L

LiFSO₃: Not used

### Comparative Example 2

A non-aqueous electrolyte secondary battery was produced in the same manner as in Example 1 except that the width to form the positive electrode active material layer in [Production of Positive Electrode Plate] above was changed to 100 mm, the width to form the negative electrode active material layer in [Production of Negative Electrode Plate] above was changed to 104 mm, and electrolyte solution 1 was replaced by an electrolyte solution 3 described below.

### Electrolyte Solution 3

Solvent: EC/EMC (volume ratio, 1:3)

LiPF₆ concentration (concentration A): 1 mol/L

LiFSO₃ concentration (concentration B): 0.08 mol/L

### Comparative Example 3

A non-aqueous electrolyte secondary battery was produced in the same manner as in Example 1 except that the width to form the positive electrode active material layer in [Production of Positive Electrode Plate] above was changed to 100 mm, the width to form the negative electrode active material layer in [Production of Negative Electrode Plate] above was changed to 104 mm, and electrolyte solution 1 was replaced by an electrolyte solution 4 described below.

### Electrolyte Solution 4

Solvent: EC/EMC (volume ratio, 1:3)

LiPF₆ concentration (concentration A): 1 mol/L

LiFSO₃ concentration (concentration B): 0.1 mol/L

### Comparative Example 4

A non-aqueous electrolyte secondary battery was produced in the same manner as in Example 1 except that the width to form the positive electrode active material layer in [Production of Positive Electrode Plate] above was changed to 100 mm, the width to form the negative electrode active material layer in [Production of Negative Electrode Plate] above was changed to 104 mm, and electrolyte solution 1 was replaced by an electrolyte solution 5 described below.

### Electrolyte Solution 5

Solvent: EC/EMC (volume ratio, 1:3)

LiPF₆ concentration (concentration A): 1 mol/L

LiFSO₃ concentration (concentration B): 0.2 mol/L

### Comparative Example 5

A non-aqueous electrolyte secondary battery was produced in the same manner as in Example 1 except that the width to form the positive electrode active material layer in [Production of Positive Electrode Plate] above was changed to 100 mm, the width to form the negative electrode active material layer in [Production of Negative Electrode Plate] above was changed to 104 mm, and electrolyte solution 1 was replaced by an electrolyte solution 6 described below.

### Electrolyte Solution 6

Solvent: EC/EMC (volume ratio, 1:3)

LiPF₆ concentration (concentration A): 1 mol/L

LiFSO₃ concentration (concentration B): 0.25 mol/L

### Comparative Example 6

A non-aqueous electrolyte secondary battery was produced in the same manner as in Example 1 except that electrolyte solution 1 was replaced by electrolyte solution 2.

### Comparative Example 7

A non-aqueous electrolyte secondary battery was produced in the same manner as in Example 1 except that electrolyte solution 1 was replaced by electrolyte solution 3.

### Example 2

A non-aqueous electrolyte secondary battery was produced in the same manner as in Example 1 except that electrolyte solution 1 was replaced by an electrolyte solution 7 described below.

### Electrolyte Solution 7

Solvent: EC/EMC (volume ratio, 1:3)

LiPF₆ concentration (concentration A): 1 mol/L

LiFSO₃ concentration (concentration B): 0.15 mol/L

### Example 3

A non-aqueous electrolyte secondary battery was produced in the same manner as in Example 1 except that electrolyte solution 1 was replaced by electrolyte solution 5.

### Comparative Example 8

A non-aqueous electrolyte secondary battery was produced in the same manner as in Example 1 except that electrolyte solution 1 was replaced by electrolyte solution 6.

### Example 4

A non-aqueous electrolyte secondary battery was produced in the same manner as in Example 1 except that electrolyte solution 1 was replaced by an electrolyte solution 8 described below.

### Electrolyte Solution 8

Solvent: EC/EMC (volume ratio, 1:3)

LiPF₆ concentration (concentration A): 1.5 mol/L

LiFSO₃ concentration (concentration B): 0.25 mol/L

### Example 5

A non-aqueous electrolyte secondary battery was produced in the same manner as in Example 1 except that electrolyte solution 1 was replaced by an electrolyte solution 9 described below.

### Electrolyte Solution 9

Solvent: EC/EMC (volume ratio, 1:3)

Concentration A=1.0 mol/L

LiPF₆ concentration: 0.9 mol/L

LiBF₄ concentration: 0.1 mol/L

LiFSO₃ concentration (concentration B): 0.2 mol/L

### Comparative Example 9

A non-aqueous electrolyte secondary battery was produced in the same manner as in Example 1 except that electrolyte solution 1 was replaced by electrolyte solution 7 and battery restraining was not performed.

### Initial Activation of Non-Aqueous Electrolyte Secondary Battery

After the non-aqueous electrolyte secondary battery was produced in the manner described in the Examples, initial activation of the battery was carried out by charging at 4.2 Vcccv in an environment at 25°° C. at a value of current of C/10, storing at 60° C. for 24 hours, and discharging at a value of current of C/10 to 3 V.

### Method of Evaluation of Non-Aqueous Electrolyte Secondary Battery

### [Measurement of Output Resistance]

In an environment at 25° C., charging was performed at a value of current of C/3 up to SOC of 50%, followed by 30 minutes of rest, and the voltage of the battery was measured (=V0). Subsequently, discharging was performed in an environment at 25°° C. at a value of current of 2 C for 10 seconds. After a lapse of 10 seconds, the voltage of the battery was measured (=V1), and the output resistance of the battery was calculated by the following equation.

$$Capacity retention = ( ( 500 th - cycle discharged capacity ) / ( first - cycle discharged capacity ) ) \times 100 ( \% )$$

The output resistance is shown in Table 1, where the values of Comparative Examples 1 to 5 are relative to the value of Comparative Example 1 which is regarded as 100%, and the values of Examples 1 to 5 and Comparative Examples 6 to 9 are relative to the value of Comparative Example 6 which is regarded as 100%.

### [Evaluation of Cycling Performance]

After the measurement of output resistance as described above, cycle testing was carried out. The conditions for the cycle testing were as follows: multiple cycles of charging and discharging were carried out, where a single cycle consisted of charging at 4.2 Vcccv at a value of current of 2 C and discharging at a value of current of C/2 to 3 V in an environment of 25° C. The ratio of the discharged capacity at the 500th cycle to the discharged capacity at the first cycle was defined as cycle capacity retention.

$$Resistance = ( V 0 - V 1 ) / 2 C ( value of current )$$

Results are shown in Table 1.

TABLE 1

| | Width of | | | | | | | | |
|---|---|---|---|---|---|---|---|---|---|
| | positive | | | | | | | | |
| | electrode | | | | Total | | | | |
| | active | | | | concentration | | | | Cycle |
| | material | Restraining | Type of | Type of | of electrolyte | Concentration | | Output | capacity |
| | layer | pressure | electrolyte | electrolyte | salt | of LiFSO₃ | A/B | resistance | retention |
| | (mm) | (MPa) | salt | solution | A (mol/L) | B (mol/L) | ratio | (%) | (%) |
| Comp. | 100 | 0.5 | LiPF₆ | Electrolyte | 1 | — | — | 100 | 88 |
| Ex. 1 | | | | solution 2 | | | | | |
| Comp. | 100 | 0.5 | LiPF₆ | Electrolyte | 1 | 0.08 | 12.5 | 94 | 89 |
| Ex. 2 | | | | solution 3 | | | | | |
| Comp. | 100 | 0.5 | LiPF₆ | Electrolyte | 1 | 0.1 | 10.0 | 93 | 90 |
| Ex. 3 | | | | solution 4 | | | | | |
| Comp. | 100 | 0.5 | LiPF₆ | Electrolyte | 1 | 0.2 | 5.0 | 90 | 91 |
| Ex. 4 | | | | solution 5 | | | | | |
| Comp. | 100 | 0.5 | LiPF₆ | Electrolyte | 1 | 0.25 | 4.0 | 91 | 90 |
| Ex. 5 | | | | solution 6 | | | | | |
| Comp. | 150 | 0.5 | LiPF₆ | Electrolyte | 1 | — | — | 100 | 86 |
| Ex. 6 | | | | solution 2 | | | | | |
| Comp. | 150 | 0.5 | LiPF₆ | Electrolyte | 1 | 0.08 | 12.5 | 94 | 88 |
| Ex. 7 | | | | solution 3 | | | | | |
| Ex. 1 | 150 | 0.5 | LiPF₆ | Electrolyte | 1 | 0.1 | 10.0 | 93 | 90 |
| | | | | solution 1 | | | | | |
| Ex. 2 | 150 | 0.5 | LiPF₆ | Electrolyte | 1 | 0.15 | 6.7 | 91 | 91 |
| | | | | solution 7 | | | | | |
| Ex. 3 | 150 | 0.5 | LiPF₆ | Electrolyte | 1 | 0.2 | 5.0 | 90 | 90 |
| | | | | solution 5 | | | | | |
| Comp. | 150 | 0.5 | LiPF₆ | Electrolyte | 1 | 0.25 | 4.0 | 91 | 85 |
| Ex. 8 | | | | solution 6 | | | | | |
| Ex. 4 | 150 | 0.5 | LiPF₆ | Electrolyte | 1.5 | 0.25 | 6.0 | 92 | 90 |
| | | | | solution 8 | | | | | |
| Ex. 5 | 150 | 0.5 | LiPF₆ + LiBF₄ | Electrolyte | 1 | 0.2 | 5.0 | 92 | 90 |
| | | | | solution 9 | | | | | |
| Comp. | 150 | 0 | LiPF₆ | Electrolyte | 1 | 0.15 | 6.7 | 102 | 83 |
| Ex. 9 | | | | solution 7 | | | | | |

In Comparative Examples 1 to 5 where the width of the positive electrode active material layer was 100 mm and thus the width of the electrode assembly was relatively small, a decrease of output resistance and an enhancement of cycle capacity retention were observed as the LiFSO₃ concentration increased, but no specific influence of the A/B ratio was observed. It is conjectured that, due to the relatively small width of the electrode assembly, salt concentrations tend to be uniform in the widthwise direction of the electrode assembly even during the charging cycle at a relatively high rate of 2 C, and, as a result, the electric potential of the positive electrode tends not to rise and transition metal elution from the positive electrode active material tends to be low, so, thereby, not only the resistance-lowering effect attributed to LiFSO₃ addition was exhibited but also the cycle capacity retention was slightly enhanced. To say the least, in Comparative Examples 1 to 5, a decrease of cycle retention was not observed.

In Comparative Examples 6 to 8 and Examples 1 to 5, the width of the positive electrode active material layer was 150 mm; in Comparative Examples 6 to 8 and Examples 1 to 5 where the width of the electrode assembly was relatively large, a decrease of output resistance and an enhancement of cycle capacity retention tended to be obtained as the LiFSO₃ concentration increased. In Examples 1 to 3 where the A/B ratio fell within the range of 5 to 10, the specific effect of lowering output resistance as well as a cycle capacity retention of 90% or more were obtained. Within the A/B ratio range in Examples 1 to 3, a decrease of output resistance attributed to LiFSO₃ and an enhancement of cycle capacity retention were obtained. In Comparative Example 8 where the LiFSO₃ concentration was relatively high and the A/B ratio was 4.0, cycle capacity retention decreased to a great extent. It is conjectured that because the width of the positive electrode active material layer was as large as 150 mm, charging cycles at a relatively high rate of 2 C caused a marked level of salt concentration nonuniformity in the widthwise direction of the cell, resulting in an increase of the electric potential of the positive electrode during charging. In contrast, in Examples 1 to 3 where the LiPF₆ concentration was sufficient relative to the LiFSO₃ concentration, it is conjectured that LiF film formation on the surface of the positive electrode active material was sufficient, and, as a result, transition metal elution from the positive electrode active material was reduced and thereby cycle capacity retention was maintained high. In Comparative Example 8 where the LiPF₆ concentration was low relative to the LiFSO₃ concentration, it is conjectured that LiF film formation on the surface of the positive electrode active material was insufficient, and, as a result, the electric potential rose enough for a reaction to occur between the positive electrode active material and strong-acid SO₃F⁻ to allow transition metal to elute from the positive electrode active material at a portion with insufficient LiF film formation and to be deposited on the negative electrode, causing a decrease of capacity retention. In Examples 1 to 3 where the A/B ratio fell within the range of 5 to 10, a decrease of output resistance and a cycle capacity retention of 90% or more were obtained. Good results were also obtained in Example 4 and Example 5.

In Comparative Example 9 where the battery was not restrained, the A/B ratio was 6.7 but output resistance was high and cycle capacity retention was low. It is conjectured that because the battery was not restrained, the flow of electrolyte solution should have been smooth and thereby salt concentrations tended to be uniform during cycle testing, but also because the battery was not restrained, the electrode-to-electrode distance tended to be large, resulting in high resistance and also in a great extent of capacity degradation during cycle testing.

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A non-aqueous electrolyte secondary battery comprising:
an electrode assembly; and
an electrolyte solution, wherein
the electrode assembly is a wound-type electrode assembly that is formed by winding a positive electrode plate and a negative electrode plate together with a separator interposed therebetween,
the positive electrode plate comprises a positive electrode active material layer, the negative electrode plate comprises a negative electrode active material layer, a dimension of at least one of the positive electrode active material layer and the negative electrode active material layer in a direction of an axis of winding of the electrode assembly is 150 mm or more,
the electrolyte solution includes an electrolyte salt and LiFSO₃,
the electrolyte salt includes at least one of LiPF₆ and LiBF₄,
when a total concentration of LiPF₆ and LiBF₄ in the electrolyte solution is defined as A (mol/L) and a concentration of LiFSO₃ in the electrolyte solution is defined as B (mol/L), a ratio of A to B which is expressed as an A/B ratio is from 5 to 12, and a pressure of 0.5 MPa or more is applied to the electrode assembly in an electrode plate stacking direction.

2. The non-aqueous electrolyte secondary battery according to claim 1, wherein the A/B ratio is from 6.7 to 10.

3. The non-aqueous electrolyte secondary battery according to claim 1, wherein the total concentration of LiPF₆ and LiBF₄ in the electrolyte solution defined as A is from 1 to 1.5 mol/L.

4. The non-aqueous electrolyte secondary battery according to claim 1, wherein the concentration of LiFSO₃ in the electrolyte solution defined as B is from 0.1 to 0.25 mol/L.

5. The non-aqueous electrolyte secondary battery according to claim 1, wherein a 5 length of the electrode assembly in a direction parallel to the axis of winding is 180 mm or more.

6. A battery pack comprising the non-aqueous electrolyte secondary battery according to claim 1.

7. A battery module comprising the non-aqueous electrolyte secondary battery according to claim 1.
